(19) United States
(12) Patent Application Publication
(10) Pub. No.: US 2002/0027678 A1
(43) Pub. Date: Mar. 7, 2002

(54) HOLOGRAPHIC DISPLAY SCREEN FOR AIRPLANES AND VEHICLES

(76) Inventors: THORSTEINN HALLDORSSON, MUENCHEN (DE); HANNES LUCAS, ZAISERTSHOFEN (DE); HORST SCHMIDT-BISCHOFFSHAUSEN, NEUBIBERG (DE)

Correspondence Address: FASSE PATENT ATTORNEYS, P.A., P.O. BOX 726, HAMPDEN, ME, 04444-0726, US

(21) Appl. No.: 09/367,136

(22) PCT Filed: Feb. 3, 1998
(86) PCT No.: PCT/DE98/00301

(30) Foreign Application Priority Data
Feb. 7, 1997 (DE) 197 04 740.8

(51) Int. Cl. G02B 5/32

(52) U.S. Cl. 359/15

(57) ABSTRACT

The invention relates to a holographic display screen for laser projection of at least one or more laser wavelengths, which selectively diffuses the incident narrow-band laser beam at a predetermined solid angle and simultaneously lets the wide-band ambient light through unobstructed. Said display screen has at least one holographic phase grid which is optically coupled to a transparent backing plate. The invention also relates to methods for the production and the use of said device.

The invention relates to the production and use of a holographic image screen as a display instrument when driving land vehicles, water craft and flying aircraft or the simulation thereof with the aid of full color laser projection.

The data which during driving a vehicle, for example an automobile, or flying an aircraft, which are displayed for the driver or pilot may roughly be divided into two categories, namely on the one hand information regarding the actual operation and technical condition of important individual systems (fuel quantity, pressures, temperatures, RPMs, mode of operation and so forth) and on the other hand information which serve for the locomotion, navigation, and target acquisition (speed, elevation, attitude, location, direction, and so forth).

One can assume that in the near future the quantity as well as the variety of the available actual data in both categories will increase. There will be available further actual data regarding the technical condition of the motor vehicle such as the tire pressure and regarding the braking system or in an aircraft regarding the ice formation on wings, flow separation, and material fatigue, as well as improved data regarding the destination, distance, road conditions, traffic jams, collision dangers, the most advantageous route and weather conditions.

During the development of passenger aircraft during the last 30 years the continuous increase in data did not lead to an increased demand on the pilot. To the contrary the automation of many aircraft functions led to an improved data management and an improved display. Thus, for example the radio officer and the on-board engineer became obsolete. During the last 10 years a further development commenced in the form of a variable display of the status and flying data on displays which were able to replace a substantial number of the rigid indicator instruments (glass cockpits). This development took place in addition to the increasing use of computers in the operation of aircraft and in the piloting of aircraft. The advantage hereby is that the display only occurs when it is needed. The pilot can call up the display or it appears automatically in critical situations.

A similar development is to be expected soon for motor vehicles, that is the classical fixed display instruments for fuel, oil pressure, engine temperature, RPM, kilometers driven and the speed will disappear and be replaced by a common display which either automatically or in response to call-up displays the actual or required information without delay. A number of further generated data will be available in vehicles in the near future such as stopping distance, spacing while parking, traffic guidance information and so forth which will have to be displayed on a universal display instrument.

The technical requirements which will have to be met by a future display in a vehicle are primarily an improved visibility with a very bright background, an improved color display, a higher contrast, and a finer image resolution. Furthermore, it is required that the location of the display on the image screen as well as its size, shape, and brightness are continuously variable.

A disadvantage of the indicator technique in use today in a dashboard below the outward viewing field of the pilot or driver is seen in that the indicator can be read or viewed only by nodding the head downwardly for viewing the indication in the near field or close range. In addition to this interruption of the observation of the surroundings, which interruption constitutes a substantial obstacle to the viewing especially when driving a vehicle, the eye must newly accommodate between the two observations and find its way in a changed scene which frequently leads to accidents.

For some time new display methods for combat aircraft are being developed and partially used in the field which relieved the pilot in that the display is faded as a virtual image into his viewing field or viewing direction through the cockpit window. A virtual image has the advantage that it appears in infinity whereby no accommodation of the eye or only a small accommodation change is required for the viewing. This is a substantial advantage in the rapidly changing scene of a low flying combat aircraft where also rapid decisions are required of the pilot while the instrument indications vary continuously. The virtual display is projected either on a transparent glass pane in front of the windshield or into spectacles in the helmet worn by the pilot.

The displays generated by a monochromic CRT screen are produced by a narrow band reflector which reflects only the wavelength of the display screen and which passes the wide band light from the window or from displays in the instrument panel. The imaging optics is simultaneously so designed, that the display of the screen in the viewing field of the pilot appears as a virtual image. Display arrangements of this type which are referred to in technical terminology as head-up displays (HUDs) are for example described in the following publications: M. H. Freeman, Head-up Displays-A Review. Optics Technology, February 69, pp 63-70 and R. J. Withrington, “Optical Design of a Holographic Visor Helmet-Mounted Displays, Computer Aided Optical Design”, Proc. SPIE Vol. 14, pp. 161-170.

Efforts are also known to integrate HUDs into the windshield of passenger cars: W. Windeln, M. A. Beeck “Windschutzscheibe mit Holographischem Spiegel fuer Head-Up Displays”, ATZ “Automobiltechnische Zeitschrift” 91 (1989) Heft 10, pp. 2-6. A display system preferably for motor vehicles is described in German Patent Publication DE 3,712,663 A1 relating to a “display system for the reading of information, as much as possible free of accommodation, when the eye is adjusted to distant viewing”. The system presents the information to be displayed as virtual image in the windshield or in the area of the dashboard.

These experiments and suggestions to transfer the HUD technology from its use in combat aircraft, however require, just as the conventional technology, the use of CRTs and LCDs as image producing elements. Thus, the same limitations apply regarding low brightness, limited resolution and weak gray scale values as well as limited color contrast. A grave disadvantage of the prior art is seen in that it can display only monochromic green images which eliminates the possibility of a differentiated information formation by means of colors. Further problems of this type of display are the limited viewing angle of only a few ten degrees and the uneven motion of the image when rapid head motions are made.

This is due to the fact that the HUDs, as they are constructed today, constitute an optical element analog to a lens system in combination with a color selective mirror. With the aid of the lens, which is realized in the HUD as a diffractive structure of a holographic element, the image of a monitor is seen after deflection by the mirror through the window as an image in the far distance. Since the mirror reflects selectively only the green light of the wavelength of the recording laser of the hologram, which corresponds to the color of the monitor, the largest proportion of the ambient light passes unhindered through the hologram.

Since these functions can be performed by conventional HUDs only in a narrow angular range, they remained limited to the use in combat aircraft. In a passenger aircraft and a motor vehicle a relatively wide observation angle is required in order that the copilot, for example, or the co-driver can also notice the display. Additionally a display over the width of the outer window would be of great advantage in this context.

In connection with an improved HUD technology that could also be used in passenger aircraft and motor vehicles, the following requirements would have to be satisfied:

small weight, small installation depth,

vibration resistant and resistant to acceleration for the intended mobile operation,

utilization of the maximal display surface,

readability up to about a 600 viewing angle,

maximal surface area utilization due to an undivided display surface,

central display of critical information,

variable sequential or superimposed display of many informations, color capabilities,

at least 4 million image dots per display (resolution of about 0.5 angular minutes),

image built-up frequency of the full image of at least 100 Hz,

holographic display for utilizing three-dimensional presentation and/or readability free of accommodation, and

no re-reflection of incident light.

It is the object of the invention to provide a new hologram which is positioned outwardly in the viewing field of the pilot or driver and which satisfies the above requirements of an improved HUD for new broad application fields.

For satisfying these requirements which in part cannot be realized by a CRT display nor by an LCD display, the special characteristics of laser projection shall be utilized. These are first the small line width and the large light coherence length connected therewith and second the high beam density, that is, light power per solid angle and surface area unit. The first characteristic can be used for the efficient separation of multi-color laser light from extraneous light. The second characteristic enables an image projection with a high resolution and a large brightness. A third feature is the color quality of the summation of the three monochromatic laser lines in the selected wavelength range. Such color quality is not achievable with other methods.

The object of the invention is achieved in that instead of an imaging element as a HUD, an image screen is used as an object hologram which is so produced that it projects an image toward the viewer only when it is illuminated with incident laser light or as a back light projector, while passing wide band light through the window thereby leaving the view toward the outside free. The holographic screen is optimized so that it selectively diffracts the narrow band laser light in one or several colors with a high efficiency in a defined solid angle while substantially transmitting unaffected the broad band ambient light. As object hologram this new technique provides the special advantage that a large image display surface can be illuminated while simultaneously making available a wide viewing angle.

The object of this holographic image screen is preferably an adapted white screen which is preferably illuminated into the hologram with all utilized laser projection wavelengths. During the recording care is taken that the screen is illuminated with the object beam in such a way that the beam diffraction- or scattering characteristic is the same as is required in the later use. A spread-out beam bundle serves as a reference beam during the holographic recording. The beam bundle emanates from a location corresponding to that from which later the projection beam emanates. The hologram is preferably recorded as an off-axis hologram and illuminated, that is, the projection beam is incident on the hologram surface at a larger angle relative to the normal of the hologram surface in order that a free view is provided through the hologram without shading caused by the projector.

Depending on the type of use it is preferred that the projector is positioned in front of or behind the hologram. It depends on the position of the projector whether the hologram is produced as reflection hologram with an incident light projection or as a transmission hologram with a backlight projection. For the reproduction with a hologram either a widened image projection beam, or a point scanning beam, or a line scanning beam can be used.

For this purpose all projection methods known today may be used. For example the light valve principle may be used in which an image matrix is projected with laser illumination onto a screen by micro mirrors (digital mirror device, DMD), or by liquid crystals (liquid crystal device, LCD) in a fixed-in-space (de-spun) projection beam. The serial image projection by laser scanners is also useable whereby the image is built-up point-by-point or line-by-line.

If the hologram is formed on a transparent carrier plate in optical contact therewith, for example a glass plate, the holographic screen will appear transparent as the carrier plate under areal illumination with a broad band ambient light whereby the carrier plate is preferably dereflected to prevent reflections.

If contrary thereto the surface of the area of the holographic screen is illuminated or scanned by a laser beam out of the correct illumination direction, that is, from the location of the earlier fixed reference beam, the original image of the screen is built up again image point by image point in parallel or serially. If the projection beam is additionally modulated with image data, the image is generated for the viewer in the recording layer as if it would appear on the original screen, however with the improvements according to the invention. However care must be taken that during the recording and the reproduction the same or approximately the same laser lines are being used and that the projection emanates from the same point as the reference beam during the recording of the hologram. For assuring a high image quality care must be taken that the expansion of the image source, as seen from the screen, corresponds approximately to a point source. This last requirement is always satisfied by a scanning system. In connection with an imaged image matrix having a diagonal of 20 mm and a projection distance of 200 mm the size of the image source is 6°, which may have an influence on the quality of the image. Since the matrix is illuminated with a bundled laser radiation, a scale reduction of the source is easily realized by an intermediate imaging under 1° which very nearly approximates a point source.

In order to achieve the required angular selectivity and wavelength selectivity for a reflection hologram it is necessary that the hologram image screen has the characteristics of a volume hologram. This is preferably achieved by a recording of a volume hologram by reflection or transmission into one or several “thick” recording layers 9 (about 5 to 30 micrometer). Volume grid structures are formed by the recording and processing of the hologram as an image of the screen independently of one another for the different wavelengths used. Under the so-called BRAGG-interference-condition of the grid structure which is satisfied each time only for one wavelength and one illumination angle, the light is reflected back or diffracted and a light image of the screen with its original scattering characteristic appears when viewing the hologram. This repeats itself for other discrete wavelengths with their allocated grid structures within the same layer or further layers to form a heterodyned total picture which represents, when correct color coordination is present, the image of the original white screen. Light of other wavelengths and wideband light is substantially passed through undiminished due to the missing accordance with the BRAGG conditions provided it is not incident out of the direction of the laser projection. Stray light that does not fall into the +1 diffraction order, such as proportions of the 0 and first order, is not reflected back but passes through the hologram where it is easily blanked out.

It is possible to use “thick” as well as “thin” transmission holograms for the observation in transmitted light. The decision which type should be used depends on the available recording materials, their costs, the desired diffraction efficiency and the type of reproduction. A high angular selectivity and wavelength selectivity can be achieved particularly with thick holograms.

In the here suggested recording of a thin hologram in one step the screen is exposed as a two-dimensional grid structure. The known recording geometry according tho Leith and Upatnik is used with a divergent reference beam. During reproduction with a projection beam which corresponds to the reference beam, the screen appears as a virtual image (in the first diffraction order) and can be used directly as such. The interfering light proportion in the 0-diffraction order and in the other diffraction orders are minimized and are absorbed outside of the hologram.

As in connection with other holograms of this type, the image of the screen appears behind the hologram plate at the same location as during the recording.

For further applications it is suggested that the transmission hologram of the screen is produced in two steps. The first step is then the same as above described. However, here instead of using the virtual image, the real image of the screen is used as object for a second recording and thereby optimized in this sense. This has the advantage that the position of the screen image during reproduction can be freely selected relative to the hologram plate in the plane of, or in front of, or behind the hologram plane. For most applications however screen images are desired with the screen position far behind the screen.

Various optical elements such as lenses, curved mirrors or holographic optical elements also may be installed into the beam pass of the real image. These elements vary the image of the screen in the copy, for example by enlargement and by setting the image at a far distance.

After the production of the image screen hologram additional optical imaging elements such as lenses, curved mirrors or holographic optical elements may be integrated into the beam pass to the viewer. These elements vary the image geometrically, for example by enlargement or scale reduction.

A white holographic screen is, as explained above, preferably prepared by incorporating a screen with all the used laser wave lengths for example red, green and blue (RGB) into the same hologram. In this connection there are three different realization possibilities. First, three exposures of all colors into one recording layer may be performed. Second, several layers of different spectral sensitivities may be stacked and adapted to the different laser wavelengths. Third, the different recording materials can be arranged next to each other, for example in punctiform as RGB-triple within each image point in a triangular arrangement in the manner of the phosphors arranged in a television delta shadow mask tube or as three neighboring vertical RGB strips in the manner of the phosphors in the known television trinitron tube.

A recording of the hologram with three different colors in a single thin layer according to the first alternative method suggested, has the problem that each individual grid structure also diffracts the light of the other wave lengths. With such a screen, when used for triple color projection, nine different stray lobes are produced in three different colors of which three coincide to a white lobe which then provides the actual viewing light. The other stray lobes may be suppressed by blanking out with additional holograms as will be described below.

In a stack construction of the layers, for example three different recording materials may be used which are adapted to the colors. In the case using three laterally arranged layers for the different colors it is possible to additionally suppress the color “cross talk” as in the cathode ray tube.

The invention further provides that “thick” transmission holograms are used for the recording of the screen particularly in applications in which a high selectivity of the hologram with regard to the reproduction wavelength and the beam incidents direction is of advantage.

In thick holograms a volume grid is formed during the recording in the recording layer having as a rule a thickness in the range of 5 to 30 micrometer. Due to the interference between neighboring partial beams which are phase shifted relative to each other the BRAGG-condition applies during reproduction for the constructive interference. Thus, a strong diffraction efficiency for the recording wavelength and the illumination direction of the reference beam are integrated into the screen and wide-band light passes for the most part unhindered through the screen.

As in a “thin” hologram either several recordings of the screen for different colors can be made in the same hologram layer or in different layers arranged in a row or next to each other with an adapted color sensitivity.

It is possible to influence the holographic image of the screen in reflection holograms and in transmission holograms by the installation of optical additional elements into the beam paths of the reference beam or of the object beam.

Thereby, it is for example possible to vary the angle of radiation of the holographic screen relative to the original screen with regard to elevation and azimuth. Further, the brightness distribution over the screen can be adjusted differently and image faults of the projection optics can be subsequently improved.

Recording materials for the “thin” holograms are for example suitably selected from silver halogenate materials or photo resist materials. Silver halogenate materials, dichromate gelatine or photo polymer materials are preferred for the “thick” holograms.

The production of such holographic image screens for front projection and rear projection with lasers has been described above by way of example. Such production can however be performed in a multitude of different ways and with different steps which are known to the person of ordinary skill in the art at the time the time the invention was made and which are understood. Some of these steps are already described in the older German patent applications 197 00 162.9 and 197 03 592.2 for holographic image screens for front and rear projection with optical absorbers coupled thereto. These steps can be applied to the present new and changed purpose.

The invention will be described in more detail in the following with reference to example embodiments shown in part schematically in the Figs., wherein:

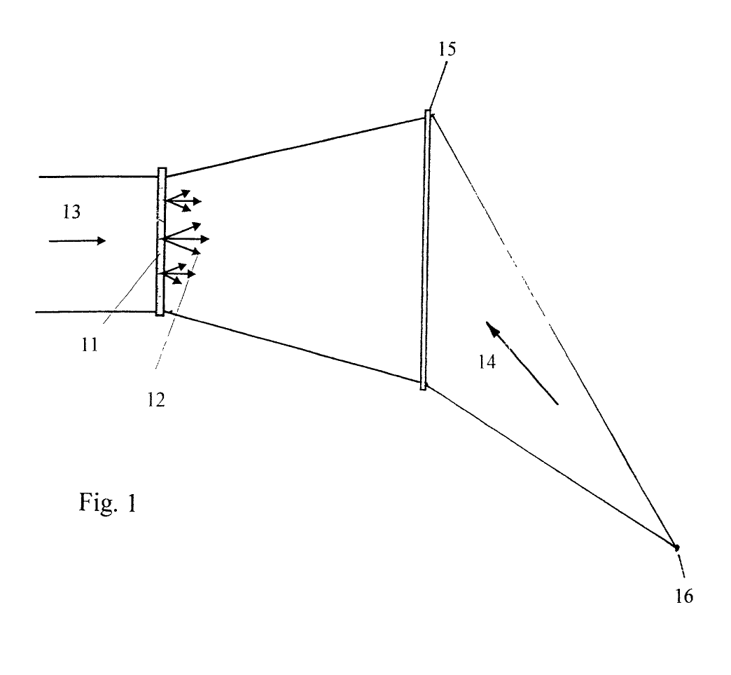

FIG. 1 shows the direct recording of a reflection hologram of an object screen according to the known method of Yu. N. Denisyuk by transmission;

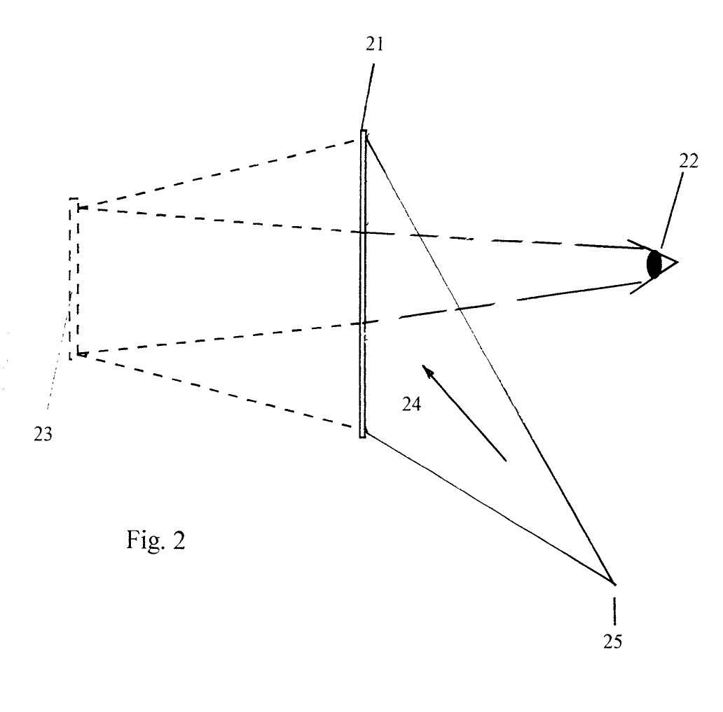

FIG. 2 shows the observation of the holographic image of the screen in a reflection hologram;

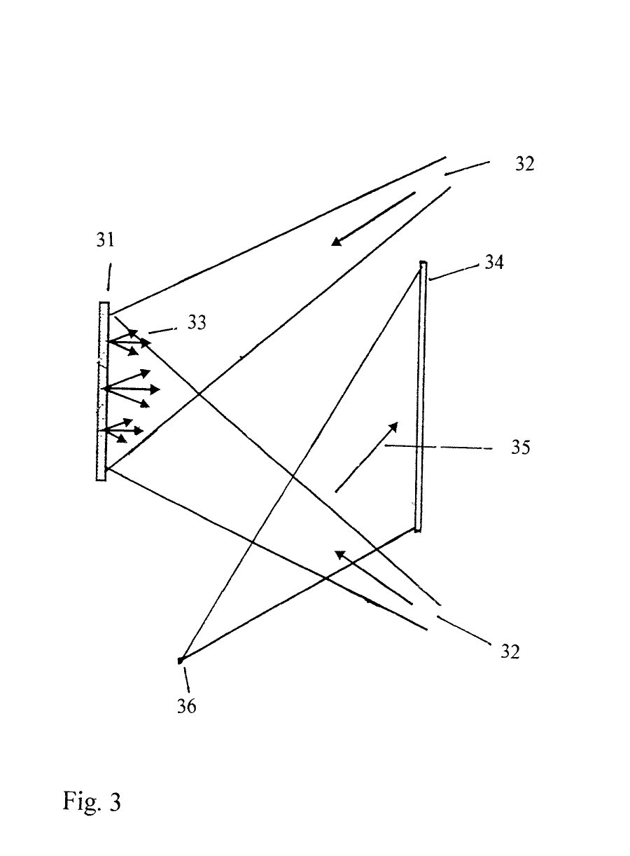

FIG. 3 shows the recording of a transmission hologram of an object screen by reflection after the known method of Leith and Upatnik;

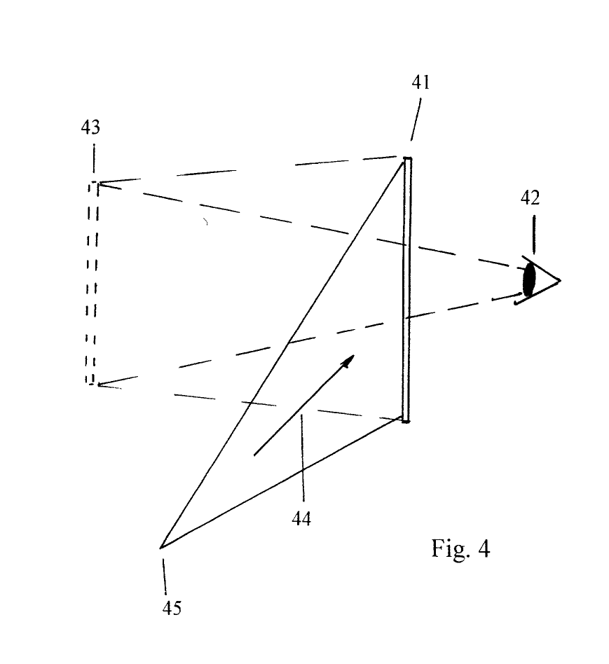

FIG. 4 shows the observation of the holographic image of the screen in a transmission hologram; and

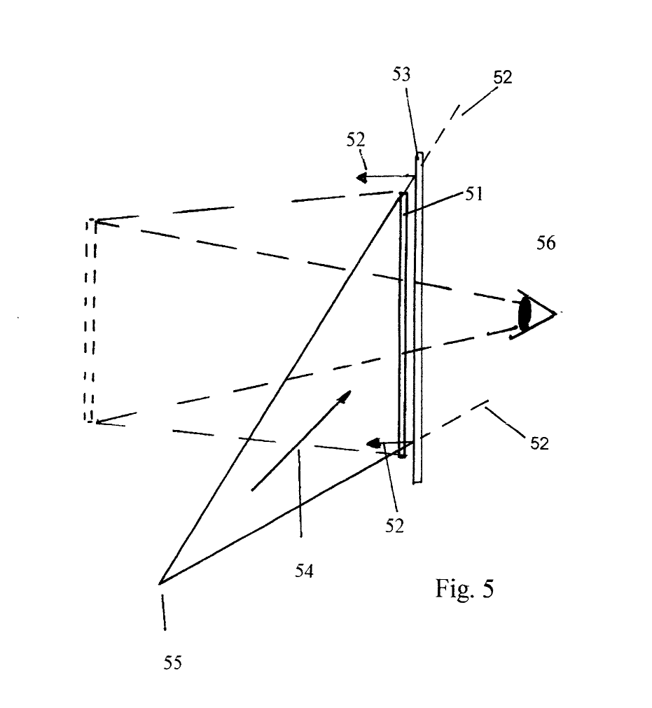

FIG. 5 shows the supplementation of the transmission hologram with a reflection hologram for suppressing stray light.

FIG. 1 shows the recording of a transparent screen 11 by reflection techniques. The diffusively scattered light 12 of the object beam 13 forwardly out of the screen is superimposed or heterodyned with the light of the reference beam 14. Here, the reference beam from the point source 16 impinges from the opposite side on the hologram plate 15 opposite the object light 12. The illumination of the screen takes place here preferably from the back, whereby, for example, advantages are achieved relative to the light intensity of the arrangement. Further, correcting steps are easily possible relative to the stray light distribution in the object beam or the reference beam.

FIG. 2 shows the image projection onto the reflection hologram 21 and the observation 22 of the virtual screen image 23. The projection beam 24 emanates from the same location 25 as the reference beam in FIG. 1. The virtual screen image appears at the same location as the object screen during recording in FIG. 1.

FIG. 3 shows the recording of a reflecting screen 31 by transmission techniques. The illumination light 32 falls onto the screen from several directions. The back scattered light from the screen 32 is superimposed in the hologram 34 on the divergent reference beam 35 emanating from the location 36.

FIG. 4 shows the image projection onto the transmission hologram 41 and the observation 42 of the virtual screen image 43. The project beam 44 emanates from the same location 45 as the reference beam in FIG. 3. The virtual screen image appears at the same location as the object screen during the recording in FIG. 3.

FIG. 5 shows the avoidance of interference light out of the holographic screen. A small portion of the incident light passes as 0 order 52 without deflection through the hologram which is the transmission hologram 51. This interference light can be efficiently back scattered by a reflection hologram of the screen 53. The reflection hologram is designed for the same projection beam 54 from the same source 55. Thus, the stray light does not enter into the space next to the viewer 56.

Image screens can be recorded with the above described methods as reflection holograms or as transmission holograms. The object screen is used as the master for a reproduction of the holograms. As is known to a person of ordinary skill in this art when the invention was made, it is possible to produce from the object screen further so-called master holograms which produce real images of the screen. The master can now be used as object master for further recordings of the image screen in a second step. The production of a master facilitates the reproduction of a large number of copies of the image screen hologram. This 2-step method also widens the possibilities for influencing the final image screen hologram relative to the image position, the stray characteristic and the brightness distribution.

The screen master for the holographic recordings need not be plane. Rather, any desired 3-dimensional surface structure can be used. For special projections, for example curved or vaulted hologram screens can be of advantage.

The installation of optical additional elements in the beam path of the reference beam makes it possible to influence the holographic image of the screen for example with regard to the brightness distribution of the reproduction, with regard to the spacial radiation characteristic, or with regard to the targeted correction of image faults which occurred during the projection.

Instead of the master holograms recorded by interference optics it is possible to use computer generated holograms, or holograms produced by computer generated holograms, in which a certain scattering function has been entered by computation. In view of the above it is to be understood that the holographic screen for the HUD according to the invention can be used for one or more laser lines. These laser lines need not necessarily be part of the visible spectrum. Rather, they may be in the UV or IR range when suitable recording materials are used for the recording of images with technical sensors such as cameras, photo detectors or photo detector arrays.

Although high requirements are made with regard to the spectral narrow band characteristic (timely coherence) of the illumination source for the image screen recording, the reproduction can be performed by using light sources with individual sharp spectral lights such as lasers, gas discharge lamps, filtered wide band discharge lamps such as halogen lamps or glow lamps.

When the holographic image screen is used as a head-up display in an aircraft or vehicle it can be positioned either in front of the windshield or it may be integrated into the windshield.

The holographic image screen can also be used as a so-called helmet mounted (HMD) where it is installed into the open spectacles of the helmet and illuminated from the side in a front projection or a rear projection.

1. (amended) A holographic image screen for laser projection of at least one or more laser wavelengths, which selectively and diffusively scatters an incident narrow band laser radiation into a predetermined solid angle, and includes at least one holographic phase grid, characterized in that the holographic phase grid is optically coupled to a transparent carrier plate, whereby the holographic image screen passes wide-band ambient light without hindrance and appears transparent for providing a see-through outwardly through the image screen.

2. The holographic image screen of claim 1, characterized in that it comprises at least one holographic reflection volume grid.

3. The holographic image screen of claim 1, characterized in that it comprises at least one holographic transmission volume grid.

4. The holographic image screen of claim 1, characterized in that it comprises at least one holographic surface grid.

5. The holographic image screen of claim 1 to 4, characterized in that the carrier plate comprises an additional blooming coat (anti-reflection coating).

6. The holographic image screen of claim 4, characterized in that it comprised three holographic surface grids allocated to three primary colors.

7. The holographic image screen of claim 2 and 3, characterized in that it comprises three holographic volume grids allocated to their primary colors.

8. The holographic image screen of claim 2, 3 and 7, characterized in that it comprises three holographic volume grids in a single layer.

9. The holographic image screen of claim 2, 3 and 7, characterized in that it comprises three holographic volume grids in a plurality of layers.

10) Amended: The holographic image screen of claim 2,3 and 7, characterized in that different holographic layers with allocated primary colors are arranged next to one another.

11. The holographic image screen of claim 3 to 7, characterized in that a volume reflection hologram is set in front of the transmission hologram in the direction toward the viewer, said reflection hologram reflection back interfering light out of the transmission hologram.

12. The holographic image screen of claim 11, characterized in that the valve reflection hologram is constructed as a holographic mirror which directionally reflects the interfering radiation.

13. The holographic image screen of claim 11, characterized in that volume reflection hologram is constructed as a reflector which diffusively reflects the interfering radiation.

14. (amended) The holographic image screen of claim 1 to 13, characterized by a light source which produces images on the screen by serial point scanning of a modulated image beam.

15. (amended) The holographic image screen of claim 1 to 13, characterized by a light source which produces images by parallel line scanning of a modulated image line.

16. (amended) The holographic image screen of claim 1 to 13, characterized by a light source which produces images on the screen by an areal, space fixed (de-spun) projection of an image matrix of a light valve modulator.

17. (amended) The holographic image screen of claim 1 to 16, characterized by narrow band light emitting diodes as light sources for the image reproduction instead of laser sources.

18. (amended) The holographic image screen of claim 1 to 16, characterized by a spectrally filtered wide band lamp for the image reproduction.

19. (amended) A method for producing a holographic image screen for laser projection of one or more laser wave lengths, which selectively and diffusively scatters an incident laser radiation into a predetermined solid angle, and includes at least one holographic phase grid, whereby a hologram is recorded , wherein a diffusively reflecting screen is used as an object, characterized in that the hologram is formed on a transparent carrier plate, so that the holographic image screen is permeable for wide band ambient light, for providing a free see-through.

20. (amended) The method of claim 19, characterized in that the hologram is recorded in a single step with a divergent reference beam as a Leith-Upatnik transmission hologram or as a Denisyuk reflection hologram.

21. (amended) A method for producing a holographic image screen of claim 1 to 13, whereby a master hologram is used for the production of the holographic image screen, characterized in that the master hologram is first produced by a two-step process and the master hologram is used as an object master for further recordings of the image screen.

22. The method for producing a holographic image screen of claim 21, characterized in that the object is a diffusively reflecting screen with which a transmission master is produced.

23. The method for producing a holographic image screen of claim 21, characterized in that the object. is a diffusively transmitting screen with which a transmission master or a reflection master is produced.

24. The method for producing a holographic image screen of claim 21 to 23, characterized in that during the recording of the screen hologram out of the master, the image plane of the screen lies in the plane of the hologram.

25. The method for producing a holographic image screen of claim 21 to 23, characterized in that during the recording of the screen hologram out of the master, the image plane of the screen lies in the plane in front of the hologram plane.

26. The method for producing a holographic image screen of claim 21 to 23, characterized in that during the recording of the screen hologram out of the master, the image plane of the screen lies in the plane behind the hologram plane.

27. The method for producing a holographic image screen of claim 19 to 25, characterized in that in at least one of the recording steps the brightness distribution an image faults are corrected by optical additional elements in the beam path.

28. The method for producing a holographic image screen of claim 19 to 26, characterized in that in at least one of the recording steps optical elements are installed in the reference beam path, which optical elements compensate image faults of the laser scanner.

29. The method for producing a holographic image screen of claim 19 to 26, characterized in that optical elements are installed in the reference beam path, which optical elements compensate image faults during areal projection.

30. The method for producing a holographic image screen of claim 19 to 26, characterized in that the total scattered light distribution of the holographic screen is adjusted by multi-beam illumination of the screen.

31. The method for producing a holographic image screen of claim 19 to 26, characterized in that additional optical imaging elements are introduced into the beam path of the real image for geometrically varying this master hologram in the copy.

32. The method for producing a holographic image screen of claim 21, characterized in that a computer generated hologram is used for producing the holographic image screen.

33. The method for producing a holographic image screen of claim 1 to 31, characterized in that a holographic optical element is coupled with the image of the screen in the eye of the viewer.
